(19) United States
(12) Patent Application Publication
(10) Pub. No.: US 2017/0261967 A1
(43) Pub. Date: Sep. 14, 2017

(54) MACHINE CONTROL DEVICE THAT ADJUSTS OPERATING CONDITIONS OF MULTIPLE MANUFACTURING MACHINES, AND PRODUCTION SYSTEM

(71) Applicant: FANUC CORPORATION, Yamanashi (JP)

(72) Inventors: Yoshifumi SHIMURA, Yamanashi (JP); Keisuke TSUJIKAWA, Yamanashi (JP); Shinichi KUWAHATA, Yamanashi (JP)

(21) Appl. No.: 15/454,258

(22) Filed: Mar. 9, 2017

(30) Foreign Application Priority Data
Mar. 10, 2016 (JP) 2016-047466

(51) Int. Cl. G05B 19/418

(52) U.S. Cl. CPC G05B 19/4188; G05B 2219/31001

(57) ABSTRACT

A machine control device includes a command unit that outputs individual operation commands to respective manufacturing machines; a power excess/shortage decision unit that decides whether time-series data on total power consumption of the manufacturing machines associated with the operation commands has maximum peak power larger than a power supply capacity of the power facility; and
an operation command adjustment unit that adjusts the operation commands to the manufacturing machines from the command unit so as to adjust the maximum peak power to the power supply capacity of the power facility or less and maximize a production amount of the manufacturing machines.

### BACKGROUND OF THE INVENTION

1. Field of the Invention

The present invention relates to a machine control device that adjusts the operating conditions of multiple manufacturing machines, and a production system.

2. Description of the Related Art

In a manufacturing factory, parts are machined or welded by a manufacturing machine such as machine tools or a robot. For manufacturing of products, multiple manufacturing machines constitute a manufacturing line, for example, a manufacturing cell. In this case, the manufacturing machines constituting a manufacturing cell are controlled by the controllers of the respective manufacturing machines.

The manufacturing machines operate according to individual commands from the controllers, for example, a speed command and an operation start timing command, and thus operation commands that consume a large amount of power may be outputted to the manufacturing machines substantially at the same time. In this case, if the total power consumption of the manufacturing machines exceeds the power supply capacity of a power facility for the factory, unfortunately, power shortage may cause insufficient performance of the manufacturing machines and thereby reduce productivity (production amount).

In a method for avoiding the problem, the power supply capacity of a power facility for a factory is changed to a sufficiently large power supply capacity relative to maximum peak power in the operations of multiple manufacturing machines. However, the larger the power supply capacity set for the power facility, the higher the electric charge to be paid to a power company. Thus, if the power shortage temporarily occurs, typically, operation commands to the manufacturing machines are manually adjusted from the operator's panels of the manufacturing machines so as to maximize a production amount in the range of the power supply capacity of the power facility.

Moreover, monitoring of the power consumption of multiple manufacturing machines has been proposed to reduce the power consumption of a factory. For example, Japanese Patent No. 5218453 discloses an apparatus for measuring the operating conditions of manufacturing machines, e.g., press machines. In this apparatus, the power consumption of the manufacturing machine is obtained and the operating condition of the manufacturing machine is identified from the obtained power consumption. Specifically, it is decided whether the manufacturing machine is operated, stopped, or turned off. Furthermore, the duration of an operating condition and the power consumption of each of the manufacturing machines are stored in a storage unit in association with the operating condition. After that, a production manager analyzes the manufacturing machines based on information in the storage unit to decide whether time and power consumption have been considerably wasted or not, and then the production manager takes some measures for reducing the wasted time and power consumption.

However, as described above, in order to prevent a reduction in productivity without increasing the power supply capacity of a power facility for a factory, an operator in the factory conventionally needs to adjust operation commands to manufacturing machines through the control panels of the respective manufacturing machines.

As described in Japanese Patent No. 5218453, this method requires an operation for analyzing information including the operating conditions and power consumption of the manufacturing machines. Such an operation increases a burden to an operator, requiring a technique of automatically adjusting the operation commands to the manufacturing machines without manual operations so as to maximize a production amount in the range of the power supply capacity of a power facility for a factory.

### SUMMARY OF THE INVENTION

The present invention provides a machine control device and a production system that can improve productivity in the range of the power supply capacity of a power facility for a factory.

A first aspect of the present disclosure provides a machine control device that controls multiple manufacturing machines connected to a power facility,

the machine control device including:

a command unit that outputs individual operation commands to the respective manufacturing machines;

a machine information retrieval unit that retrieves, at predetermined intervals, information including at least the operating conditions, power consumption, and production amounts of the manufacturing machines when the manufacturing machines operate according to the operation commands of the command unit;

a power excess/shortage decision unit that decides whether time-series data on total power consumption of the manufacturing machines associated with the operation commands has maximum peak power larger than the power supply capacity of the power facility, according to the information stored in a storage unit that sequentially stores the information about the manufacturing machines or according to the information retrieved by the machine information retrieval unit; and

an operation command adjustment unit that adjusts the operation commands to the manufacturing machines from the command unit according to the information stored in the storage unit or the information retrieved by the machine information retrieval unit so as to adjust the maximum peak power to the power supply capacity of the power facility or less and maximize the production amount of the manufacturing machines associated with the operation commands.

According to the machine control device of the first aspect, a second aspect of the present disclosure provides a machine control device further including a machine information correction unit that corrects the information on the manufacturing machines in the storage unit to information on the manufacturing machines with the operation commands adjusted by the operation command adjustment unit.

According to the machine control device of the first or second aspect, a third aspect of the present disclosure provides a machine control device in which the machine information retrieval unit retrieves information on the power consumption from a wattmeter provided in each of the manufacturing machines.

According to the machine control device of the first or second aspect, a fourth aspect of the present disclosure provides a machine control device in which the machine information retrieval unit retrieves information that estimates information on the power consumption from machining programs and driving parameters of the manufacturing machines associated with the operation commands.

According to the machine control device of one of the first to fourth aspects, a fifth aspect of the present disclosure provides a machine control device further including a peak power estimation unit that estimates the total power consumption and the maximum peak power based on values of the operation commands from the command unit or information about the operating conditions or the power consumption in the storage unit.

According to the machine control device of one of the first to fifth aspects, a sixth aspect of the present disclosure provides a machine control device in which the operating conditions include a manipulated variable preset for the manufacturing machines.

According to the machine control device of one of the first to sixth aspects, a seventh aspect of the present disclosure provides a machine control device further including a power facility planning unit that produces a plan to increase or reduce the power supply capacity of the power facility based on a decision result of the power excess/shortage decision unit and outputs the contents of the plan.

According to the machine control device of one of the first to seventh aspects, an eighth aspect of the present disclosure provides a machine control device in which the command unit outputs, as the operation command, at least one of a command about at least a speed, current, or torque of the manufacturing machine and an offset command about the operation start timing of the manufacturing machine.

A ninth aspect of the present disclosure provides a production system including the machine control device according to one of the first to eighth aspects, and a host computer that is connected so as to communicate with the machine control device and indicates a production plan to the machine control device, the host computer including a database unit that receives and stores the information from the storage unit.

### BRIEF DESCRIPTION OF THE DRAWINGS

A detailed description about a typical embodiment of the present invention shown in the accompanying drawings further clarifies the object, characteristics, advantages of the present invention and other objects, characteristics, and advantages of the present invention.

FIG. 1 is a block diagram schematically showing a production system including a machine control device according to an embodiment;

FIG. 2 illustrates a first step of operating the machine control device according to the embodiment;

FIG. 3 illustrates a second step of operating the machine control device according to the embodiment;

FIG. 4 illustrates a third step of operating the machine control device according to the embodiment; and

FIG. 5 illustrates a fourth step of operating the machine control device according to the embodiment.

### DETAILED DESCRIPTION

An embodiment of the present disclosure will be described below with reference to the accompanying drawings. In the drawings, the same members are indicated by the same reference numerals. To enhance understanding, the scales of the drawings are optionally changed. The illustrated embodiment is merely an example for implementing the present invention and thus the present invention is not limited to the illustrated embodiment.

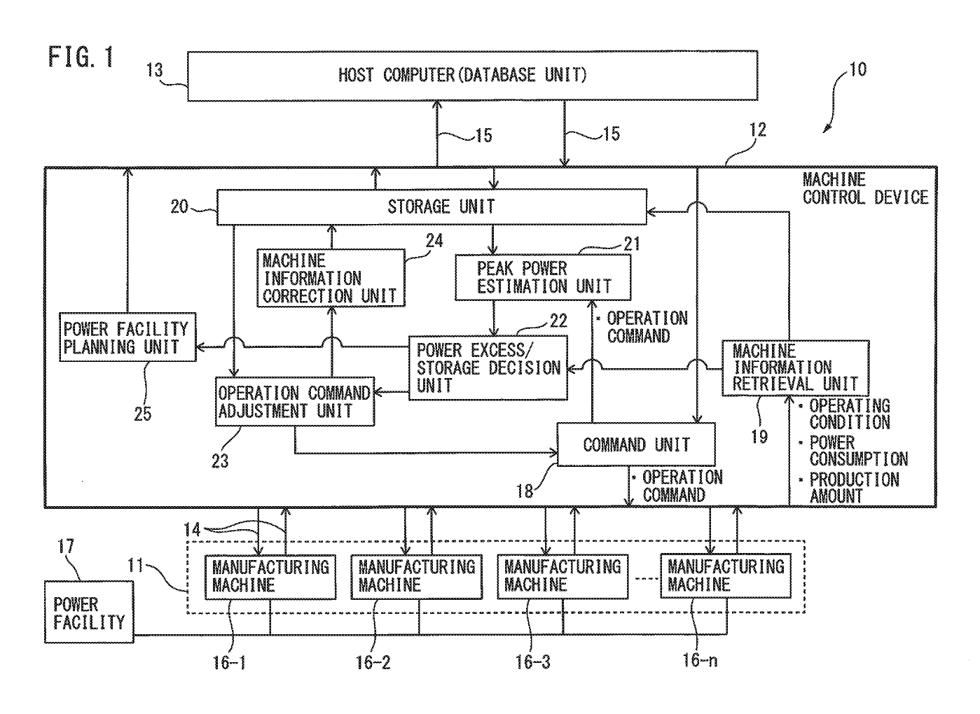

FIG. 1 is a block diagram schematically showing a production system including a machine control device according to the embodiment.

Referring to FIG. 1, a production system 10 includes at least one manufacturing cell 11, a machine control device 12, and a host computer 13.

The manufacturing cell 11 is disposed in a factory for manufacturing products, whereas the machine control device 12 and the host computer 13 are disposed in a different building from the factory. For example, the machine control device 12 may be disposed in a different building in a factory site containing the manufacturing cell 11. In this case, the manufacturing cell 11 and the machine control device 12 are preferably connected so as to communicate with each other via a network 14, e.g., an intranet.

The host computer 13 may be disposed in, for example, an office remote from the factory. In this case, the machine control device 12 and the host computer 13 are preferably connected so as to communicate with each other via a network 15, e.g., the Internet. Moreover, the host computer 13 of the present embodiment is preferably a production planning device that produces manufacturing plans for the multiple manufacturing cells 11 or manufacturing machines and manages the manufacturing conditions of the manufacturing cells 11 or the manufacturing machines. Furthermore, the host computer 13 preferably has a database unit (not shown) that stores machine information including at least information on the statuses, power consumption, and production amounts of the manufacturing machines as will be discussed later.

The manufacturing cell 11 is a set of manufacturing machines flexibly combined to manufacture products. As shown in FIG. 1, the manufacturing cell 11 of the present embodiment includes n manufacturing machines 16-1, 16-2, . . . 16-n (n is a natural number). The number of manufacturing machines is not limited in the manufacturing cell 11. The manufacturing cell 11 may be a manufacturing line where a certain workpiece is sequentially machined by the manufacturing machines into a final product. Alternatively, the manufacturing cell 11 may be a manufacturing line where at least two workpieces machined by at least two manufacturing machines are combined into a final product by another manufacturing machine during the manufacturing process.

In the present embodiment, at least two workpieces machined by at least two of the manufacturing cells 11 may be combined into a final product.

The manufacturing machines 16-1 to 16-n may be selected from the following machines: an NC machine tool, an industrial robot, a PLC, a conveyor, a measuring instrument, a tester, a press machine, an injector, a printer, a die casting machine, an injection molding machine, a food machine, a packaging machine, a welding machine, a washing machine, a coating machine, an assembling device, a mounter, a woodworking machine, a sealing device, and a cutter. Each of the machines 16-1 to 16-n includes a memory, e.g., a ROM or a RAM, a CPU, and a communication control unit (not shown). The communication control unit controls the exchange of information with a communication control unit (not shown) in the machine control device 12.

The machine control device 12 configured thus produces individual operation commands, for example, a speed command and an operation start timing command and then transmits the commands to the respective manufacturing machines 16-1 to 16-n based on a production plan instruction from the host computer 13. When the manufacturing machines 16-1 to 16-n operate according to the individual operation commands, the manufacturing machines 16-1 to 16-n obtain electric power from a power facility 17 of the factory. At this point, the maximum peak power of the total power consumption of the manufacturing machines 16-1 to 16-n may exceed the power supply capacity of the power facility 17 depending upon the operation commands transmitted to the manufacturing machines 16-1 to 16-n.

If the maximum peak power exceeds the power supply capacity, the machine control device 12 of the present application adjusts the operation commands to the manufacturing machines 16-1 to 16-n such that the maximum peak power is not larger than the power supply capacity of the power facility 17 and the manufacturing cell 11 has a maximum production amount.

A configuration example of the machine control device 12 having the above function will be specifically discussed below.

As shown in FIG. 1, the machine control device 12 of the present embodiment includes a command unit 18, a machine information retrieval unit 19, a storage unit 20, a peak power estimation unit 21, a power excess/shortage decision unit 21, an operation command adjustment unit 23, a machine information correction unit 24, and a power facility planning unit 25.

The command unit 18 produces individual commands for the manufacturing machines 16-1 to 16-n based on a production plan instruction from the host computer 13. Moreover, the command unit 18 transmits the produced operation commands to the respective manufacturing machines 16-1 to 16-n via the network 14, e.g., an intranet, operating the manufacturing machines 16-1 to 16-n.

In order to confirm whether the maximum peak power exceeds the power supply capacity depending upon the produced operation commands, the command unit 18 transmits the produced operation commands to the peak power estimation unit 21 before the manufacturing machines 16-1 to 16-n. As will be discussed later, the peak power estimation unit 21 reads, from the storage unit 20, time-series data on power consumption in the manufacturing machines 16-1 to 16-n; however, the time-series data on power consumption in the manufacturing machines associated with the operation commands may not be stored in the storage unit 20. In this case, the command unit 18 operates the manufacturing machines associated with the operation commands, allowing the machine information retrieval unit 19 to retrieve time-series data on power consumption in the manufacturing machines associated with the operation commands.

In the present embodiment, the command unit 18 outputs offset commands about the operation start timing of the manufacturing machines 16-1 to 16-n as the operation commands. In the present disclosure, however, the operation commands preferably include commands about at least the speeds, currents, or torque of the manufacturing machines 16-1 to 16-n as well as the offset commands when necessary.

The machine information retrieval unit 19 retrieves information on the manufacturing machines 16-1 to 16-n at predetermined intervals when the manufacturing machines 16-1 to 16-n operated according to the individual operation commands. The information retrieved thus on the manufacturing machines particularly includes at least information about the operating conditions, power consumption, and production amounts of the manufacturing machines 16-1 to 16-n.

The information about the operating conditions is time-series data on the machining speeds of the manufacturing machines 16-1 to 16-n. The time-series data on machining speeds is, for example, the history of speed changes during acceleration/deceleration and at constant speeds of servo motors for driving the respective manufacturing machines.

The information about power consumption is time-series data on the power consumption of the manufacturing machines 16-1 to 16-n. The time-series data on the power consumption is, for example, the history of current values outputted at the predetermined intervals from wattmeters (not shown) provided in the respective manufacturing machines 16-1 to 16-n.

The information about production amounts is information on the number of processed parts during an operation. The information is obtained by counters (not shown) provided in the respective manufacturing machines 16-1 to 16-n.

The information about operating conditions also includes the set values and driving parameters of machining programs stored in the memories of the manufacturing machines 16-1 to 16-n. For example, in the case of manufacturing machines such as an articulated robot that operates a servo motor as a driving source, the information about the operating conditions includes a pulse count and a servo control parameter at the mastering position of each axis of a robot.

The machine information retrieval unit 19 transmits the information on the manufacturing machines 16-1 to 16-n to the storage unit 20 and the peak power estimation unit 21. The storage unit 20 sequentially stores information including the operating conditions, power consumption, and production amounts of the manufacturing machines 16-1 to 16-n. The information is transmitted from the machine information retrieval unit 19.

Furthermore, the stored information about the operating conditions, power consumption, and production amounts of the manufacturing machines 16-1 to 16-n may be transmitted from the storage unit 20 to the database unit of the host computer 13 and then stored in the database unit.

The peak power estimation unit 21 reads the time-series data on the power consumption of the manufacturing machines 16-1 to 16-n from the storage unit 20 or the host computer 13 based on the operation commands from the command unit 18 to the manufacturing machines 16-1 to 16-n. Furthermore, the peak power estimation unit 21 estimates the total power consumption and maximum peak power of the manufacturing machines 16-1 to 16-n according to the read time-series data on the power consumption of the manufacturing machines 16-1 to 16-n. At the time of estimation, the offset commands about the operation start timing of the manufacturing machines 16-1 to 16-n are taken into consideration.

The power excess/shortage decision unit 22 compares the estimated maximum peak power and the predetermined power supply capacity of the power facility 17 to decide whether power is sufficient or not relative to the predetermined power supply capacity. A power supply capacity value for the decision is preferably stored beforehand in the power excess/shortage decision unit 22. If the storage unit 20 does not contain time-series data on the past power consumption of the manufacturing machines associated with the operation commands, the command unit 18 is preferably allowed to actually operate the manufacturing machines associated with the operation commands. In this case, the power excess/shortage decision unit 22 retrieves, from the machine information retrieval unit 19, time-series data on the power consumption of the manufacturing machines associated with the operation commands, and compares the maximum peak power of the total power consumption of the manufacturing machines and the power supply capacity of the power facility 17.

The operation command adjustment unit 23 adjusts the operation command to the manufacturing machine 16-1 to 16-n if the power excess/shortage decision unit 22 decides that the maximum peak power exceeds the power supply capacity of the power facility 17. At this point, the operation command adjustment unit 23 adjusts the operation commands to the manufacturing machines 16-1 to 16-n, for example, the offset commands about operation start timing such that the maximum peak power is not larger than the power supply capacity of the power facility 17 and the manufacturing cell 11 has a maximum production amount. In this adjustment, the stored information about the manufacturing machines 16-1 to 16-n in the storage unit 20 is used. Alternatively, the information about the manufacturing machines 16-1 to 16-n may be used after being retrieved by the machine information retrieval unit 19.

The machine information correction unit 24 corrects the information about the manufacturing machines 16-1 to 16-n in the storage unit 20 to information about the manufacturing machines 16-1 to 16-n with the operation commands adjusted by the operation command adjustment unit 23. The corrected information about the manufacturing machines includes at least information indicating the operating conditions, power consumption, and production amounts of the manufacturing machines 16-1 to 16-n. The machine control device 12 of the present embodiment does not always need to include the machine information correction unit 24.

The power facility planning unit 25 produces a plan to increase or reduce the power supply capacity of the power facility 17 based on the decision result of the power excess/shortage decision unit 22, and then transmits the contents of the plan to the host computer 13. The destination of the contents is not limited to the host computer 13. The destination may be a display unit or printer connected to the machine control device 12, or a personal digital assistant held by a manager or an operator. The machine control device 12 of the present embodiment does not always need to include the power facility planning unit 25.

In the present embodiment, the wattmeter (not shown) does not always need to be provided in each of the manufacturing machines 16-1 to 16-n. In other words, the power consumption of the manufacturing machines may be estimated from, for example, the set values and driving parameters of the machining programs of the manufacturing machines 16-1 to 16-n when the manufacturing machines are operated according to the individual operation commands. For example, if the manufacturing machines 16-1 to 16-n are servo press machines, the power consumption of a motor for operating the servo press machine can be estimated as follows:

The unique physical properties of the motor include a motor winding resistance (one phase) of R(Ω), a torque constant of Kt(N·m/A), a load inertia of J(Kg·m²), a motor rpm of ω(rad/sec), a motor shaft friction torque of Tf(N·m), and a motor current command value of I(A). The motor has an acceleration period, a deceleration period, and a constant-speed period based on the machining programs during machining.

In this case, in consideration of only a copper loss as a motor loss, power consumption Ea(Ws) in the acceleration of the motor can be determined by equation (1):

Ea=½×J×ω²+3×R×I2×tf1 (1)

where tf1 is an acceleration/deceleration time.

Power consumption Eb(Ws) in the deceleration of the motor can be determined by equation (2):

Eb=−½×J×ω²×Kr+3×R×I²×tf1 (2)

where Kr is a coefficient indicating the ratio of regeneration of kinetic energy.

When the motor rotates at a constant speed, power consumption Ec can be determined by equation (3):

Ec=Tf×ω×tf2+3×R×(Tf/Kt)²×tf2 (3)

where tf2 is a constant speed time.

Thus, the unique physical properties of the motor and the machining programs are identified beforehand so as to estimate the power consumption of the motor according to equations (1), (2), and (3).

The machine control device 12 may be configured using a computer system including a storage unit, a CPU (control processing unit), and a communication unit that are connected to one another via a bus.

The storage unit is, for example, a ROM (read only memory) or a RAM (random access memory). Moreover, programs stored in the ROM are executed by the CPU so as to obtain the functions and operations of the command unit 18, the machine information retrieval unit 19, the peak power estimation unit 21, the power excess/shortage decision unit 22, the operation command adjustment unit 23, the machine information correction unit 24, and the power facility planning unit 25.

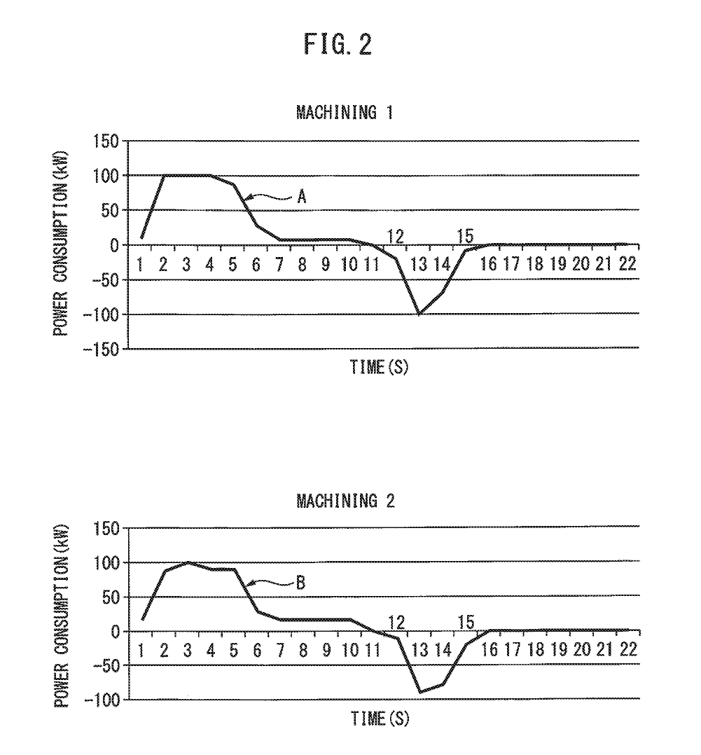

FIGS. 2 to 5 illustrate the steps of operating the machine control device 12 according to the present embodiment. Referring to FIGS. 1 to 5, the operations of the machine control device 12 according to the present embodiment will be described below.

For example, the machine control device 12 is operated while the operation commands particularly to the two manufacturing machines 16-1 and 16-2 of the manufacturing machine 16-1 to 16-n have the same operation start timing. In the following operation example, the manufacturing machines 16-1 to 16-n are servo press machines or electric injection molders. As a matter of course, the present invention is not limited to the operation example.

First, when the operation commands are produced based on a production planning instruction from the host computer 13, the command unit 18 in FIG. 1 transmits the operation commands to the peak power estimation unit 21. The operation commands are, for example, the offset commands with the same operation start timing to the servo motors of the manufacturing machines 16-1 and 16-2 and the speed commands based on the machining programs of the manufacturing machines 16-1 and 16-2.

When receiving the operation command, as shown in FIG. 1, the peak power estimation unit 21 reads, from the storage unit 20, time-series data on the power consumption of the manufacturing machines 16-1 and 16-2 associated with the operation commands. The storage unit 20 stores information about the manufacturing machines 16-1 to 16-n operated in response to the respective operation commands, particularly information including at least the operating conditions, power consumption, and production amounts of the manufacturing machines 16-1 to 16-n. For example, as shown FIG. 2, time-series data on power consumption in machining 1 and machining 2 is stored in the storage unit 20 through the machine information retrieval unit 19. A curve A in FIG. 2 indicates time-series data on the power consumption of the servo motor in a tact time of the manufacturing machine 16-1 for performing the machining 1. Moreover, a curve B in FIG. 2 indicates time-series data on the power consumption of the servo motor in a tact time of the manufacturing machine 16-2 for performing the machining 2. The tact time is a period of machining, that is, a time period from the start to end of machining. In FIG. 2, the machining 1 and the machining 2 both continue for about 22 seconds.

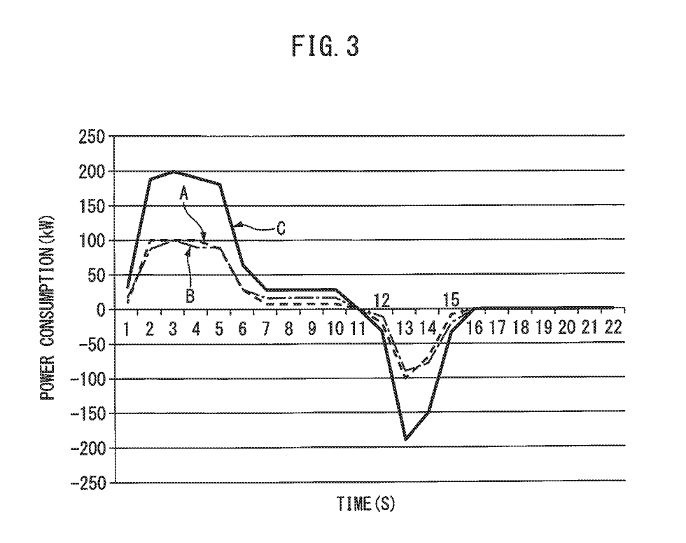

Moreover, the peak power estimation unit 21 estimates time-series data on the total power consumption of the servo motors of the two manufacturing machines 16-1 and 16-2 and the maximum peak power of the total power consumption in consideration of the same operation start timing of the servo motors of the manufacturing machines 16-1 and 16-2. FIG. 3 shows time-series data (curve C) on the total power consumption. As shown in FIG. 3, the time-series data (curve C) on the total power consumption indicates a maximum peak power value of 200 kW. As shown in FIG. 1, the peak power estimation unit 21 transmits the value of the estimated maximum peak power to the power excess/shortage decision unit 22.

Subsequently, the power excess/shortage decision unit 22 shown in FIG. 1 compares the estimated maximum peak power and a predetermined power supply capacity of the power facility 17. The predetermined power supply capacity is stored in the power excess/shortage decision unit 22 beforehand. The power excess/shortage decision unit 22 then decides whether power is sufficient or not relative to the power supply capacity.

For example, Pa(t) and Pb(t) denote functions indicating time-series data (the curve A and the curve B in FIG. 2) on the power consumption of the servo motors of the manufacturing machines 16-1 and 16-2 during machining. P(t) denoting a function indicating time-series data (the curve C in FIG. 3) on total power consumption can be expressed by equation (4):

P(t)=Pa(t)+Pb(t) (4)

where t is an operating time.

Subsequently, power excess/shortage decision unit 22 decides whether relational expression (5) is satisfied or not:

P(t)max<E (5)

where P(t)max is the maximum value of the function P(t), that is, the maximum peak power, and E is the predetermined power supply capacity of the power facility 17.

The time-series data on power consumption indicated by the functions Pa(t) and Pb(t) may be estimated using the above-mentioned equations (1), (2), and (3). Specifically, time-series data on the power consumption of the servo motors of the manufacturing machines 16-1 and 16-2 may be estimated according to operating conditions stored in the storage unit 20, for example, the set values and driving parameters of the machining programs of the manufacturing machines 16-1 and 16-2. Alternatively, the power excess/shortage decision unit 22 may actually retrieve time-series data on the power consumption of the servo meters of the manufacturing machines 16-1 and 16-2 from the machine information retrieval unit 19 and determine the maximum peak power P(t)max of the total power consumption of the servo motors.

Subsequently, if the maximum peak power P(t)max exceeds a predetermined power supply capacity E of the power facility 17 as the decision result, the operation command adjustment unit 23 shown in FIG. 1 adjusts the operation commands. Specifically, the operation command adjustment unit 23 adjusts at least the offset commands about operation start timing to the servo motors of the manufacturing machines 16-1 and 16-2 or the speed commands based on the machining programs of the manufacturing machines 16-1 and 16-2. For example, the time-series data on total power consumption indicated by the curve C in FIG. 3 has maximum peak power of 200 kW. Thus, the operation commands are adjusted if the predetermined power supply capacity E is equivalent to 150 kW.

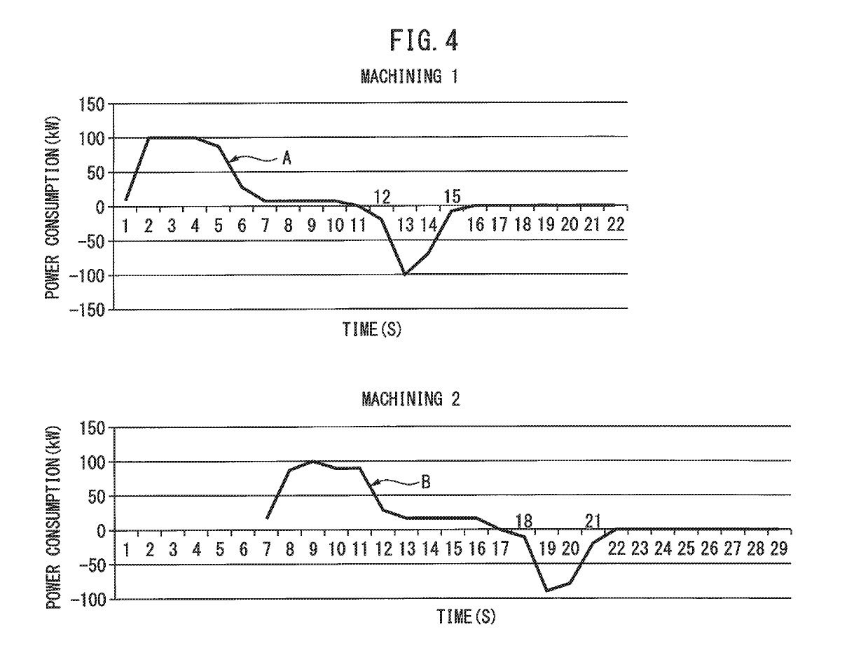

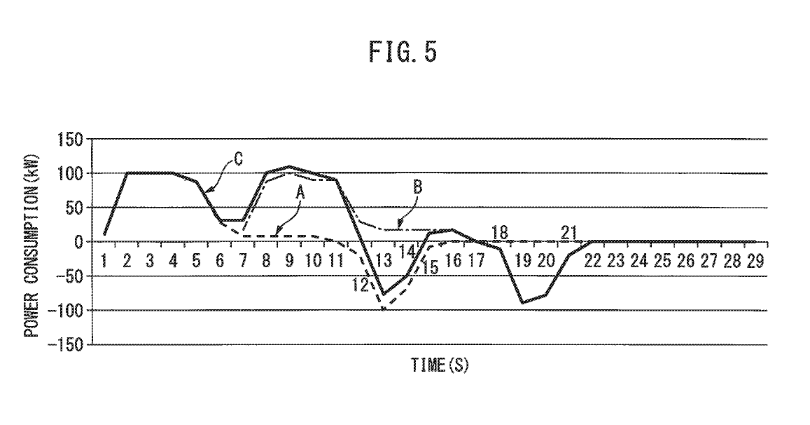

For example, the operation command adjustment unit 23 adjusts the offset commands about operation start timing to the servo motors of the manufacturing machines 16-1 and 16-2 so as to delay the start of the machining 2 from the machining 1. As shown in FIG. 4, this adjustment can temporally displace the time-series data (curve B) on power consumption in the machining 2 from the time-series data (curve A) on power consumption in the machining 1. Thus, time-series data on total power consumption in the machining 1 and machining 2 is plotted into a curve C shown in FIG. 5. As shown in FIG. 5, the maximum peak power value of time-series data (curve C) on total power consumption is about 100 kW, which is smaller than the power supply capacity E equivalent to 150 kW.

However, if the start of the machining 2 is delayed from the machining 1 as described above, the finishing time of the machining 2 is also delayed as indicated by the curve C in FIG. 5. Specifically, as the start of the machining 2 is delayed from the machining 1, a time period for obtaining a part through the machining 1 and the machining 2 is extended so as to reduce a production amount. Thus, in the present embodiment, the commands about operation start timing to the servo motors of the manufacturing machines 16-1 and 16-2 are adjusted so as to have a maximum production amount while adjusting the maximum peak power to the power supply capacity of the power facility 17 or less. If the maximum peak power is larger than the power supply capacity of the power facility 17 after only the commands about operation start timing are adjusted, the speed commands to the servo motors of the manufacturing machines 16-1 and 16-2 are also adjusted. For example, the servo motors are decelerated to suppress the power consumption of the servo motors. As a matter of course, also in the adjustment of the speed commands, a production amount is preferably maximized while the maximum peak power is adjusted to the power supply capacity of the power facility 17 or less. The production amount is determined by dividing the operating time of the manufacturing machine by a tact time.

For the manufacturing machines 16-1 and 16-2, a machine operator may set a manipulated variable, e.g., a speed override value with switches provided on the manufacturing machines 16-1 and 16-2. The speed override value is a speed ratio of actual machining in response to the speed command of the machining program. For example, if the machining program is executed with a speed override value of 50%, actual machining is performed with 50% of a speed preset in the machining program. In other words, the machining time is doubled. Thus, if a speed override value recorded in the storage unit 20 is different from a current speed override value, peak power for the current operation command cannot be correctly estimated unless the difference in speed override value is considered for time-series power consumption data recorded in the storage unit 20. In the present embodiment, machine information including the speed override value is preferably retrieved by the machine information retrieval unit 19 and is used in the peak power estimation unit 21.

Calculation examples for adjusting the offset commands about operation start timing and speed commands will be discussed below.

Each of the manufacturing machines 16-1 and 16-2 has a tact time, that is, a machining period. Thus, total power consumption P(t) expressed by equation (4) can be also expressed by equation (6):

P(t)=Pa(θa)+Pb(θb) (6)

where θa and θb are positions, that is, phases in the tact time (machining period).

The phases θa and θb can be also expressed by equations (7) and (8):

θa=2π×(t+Δta)/Ta (7)

θb=2π×(t+Δtb)/Tb (8)

where Δta and Δtb are the values of offset commands about operation start timing to the servo motors of the manufacturing machines 16-1 and 16-2, Ta and Tb are the tact times of the manufacturing machines 16-1 and 16-2, and t is an operating time.

The tact time Ta is calculated from equation (9) and the tact time Tb is calculated from equation (10):

Ta=Ta_org×Va_org/Va (9)

Tb=Tb_org×Vb_org/Vb (10)

where Ta_org and Va_org are a tact time and a speed command value before the operation command of the manufacturing machine 16-1 is adjusted, and Va is a speed command value after the adjustment.

According to equations (6) to (10), the total power consumption P(t) is calculated by adjusting the values of offset commands about operation start timing and speed commands to the servo motors of the manufacturing machines 16-1 and 16-2.

Furthermore, the manufacturing machines 16-1 and 16-2 have production amounts Na and Nb that are calculated from equations (11) and (12) below. According to equations (11) and (12), the production amounts Na and Nb are calculated by dividing the operating time t by the tact times Ta and Tb.

Na=t/Ta (11)

Nb=t/Tb (12)

According to equations (6) to (12), in order to maximize a total production amount N(=Na+Nb) of the two manufacturing machines 16-1 and 16-2, the offset command values Δta and Δtb of operation start timing and the adjusted speed command values Va and Vb are retrieved while being calculated.

Naturally, the offset command values Δta and Δtb of operation start timing and the adjusted speed command values Va and Vb are calculated so as to satisfy equation (5) of P(t)max<E.

In order to calculate the offset command values Δta and Δtb of operation start timing and the adjusted speed command values Va and Vb, it is necessary to obtain values including Ta_org, Ta_org, Va_org, Vb_org, and t in equations (6) to (12). Thus, the operation command adjustment unit 23 shown in FIG. 1 is preferably configured to obtain information on the manufacturing machines 16-1 and 16-2, particularly information including operation commands and the operation conditions and power consumption based on the operation commands from the storage unit 20 or the machine information retrieval unit 19.

After that, the operation commands adjusted by the operation command adjustment unit 23 are transmitted to the command unit 18. The command unit 18 operates the manufacturing machines 16-1 and 16-2 according to the adjusted operation commands. The operation commands adjusted by the operation command adjustment unit 23 are also transmitted to the machine information correction unit 24 shown in FIG. 1. Subsequently, the machine information correction unit 24 corrects information on the manufacturing machines 16-1 and 16-2 in the storage unit 20 to information on the manufacturing machines 16-1 and 16-2 with the operation commands adjusted by the operation command adjustment unit 23.

If the power excess/shortage decision unit 22 decides that the maximum peak power exceeds the power supply capacity of the power facility 17 for an extended period, the power facility planning unit 25 in FIG. 1 produces a plan to increase the power supply capacity of the power facility 17, and then transmits the contents of the plan to the host computer 13. Also when the power supply capacity of the power facility 17 has a large amount of surplus power with respect to the maximum peak power, the power facility planning unit 25 produces a plan to reduce the power supply capacity of the power facility 17 and then transmits the contents of the plan to the host computer 13. Naturally, the destination of the contents is not limited to the host computer 13.

In this example, the two manufacturing machines 16-1 and 16-2 of the manufacturing machines 16-1 to 16-n are operated. Naturally, two or more of the manufacturing machines 16-1 to 16-n may be operated in the present invention.

The machine control device 12 can automatically adjust the operation commands to the manufacturing machines 16-1 to 16-n such that the total power consumption of the manufacturing machines 16-1 to 16-n operated according to the individual operation commands does not exceed the power supply capacity of the power facility 17 of the factory. At this point, the operation commands to the manufacturing machines 16-1 to 16-n are adjusted so as to maximize the production amount of the manufacturing machines 16-1 to 16-n. This can improve productivity in the range of the power supply capacity of the power facility 17 for the factory.

In other words, if the operation commands of the manufacturing machines 16-1 to 16-n cause power shortage so as to degrade the performance of the manufacturing machines, the machine control device 12 can adjust the operation commands to the manufacturing machines 16-1 to 16-n without manual operations while keeping maximum productivity.

The present invention was described above according to the typical embodiment. A person skilled in the art would understand that the embodiment can be changed and various other changes, omissions, and additions may be made without departing from the scope of the present invention.

1. A machine control device that controls multiple manufacturing machines connected to a power facility,
the machine control device comprising:
a command unit that outputs individual operation commands to the respective manufacturing machines;
a machine information retrieval unit that retrieves, at predetermined intervals, information including at least operating conditions, power consumption, and production amounts of the manufacturing machines when the manufacturing machines operate according to the operation commands of the command unit;
a power excess/shortage decision unit that decides whether time-series data on total power consumption of the manufacturing machines associated with the operation commands has maximum peak power larger than a power supply capacity of the power facility, according to the information stored in a storage unit that sequentially stores the information about the manufacturing machines or according to the information retrieved by the machine information retrieval unit; and
an operation command adjustment unit that adjusts the operation commands to the manufacturing machines from the command unit according to the information stored in the storage unit or the information retrieved by the machine information retrieval unit so as to adjust the maximum peak power to the power supply capacity of the power facility or less and maximize a production amount of the manufacturing machines associated with the operation commands.

2. The machine control device according to claim 1, further comprising a machine information correction unit that corrects the information on the manufacturing machines in the storage unit to information on the manufacturing machines with the operation commands adjusted by the operation command adjustment unit.

3. The machine control device according to claim 1, wherein the machine information retrieval unit retrieves information on the power consumption from a wattmeter provided in each of the manufacturing machines.

4. The machine control device according to claim 1, wherein the machine information retrieval unit retrieves information that estimates information on the power consumption from machining programs and driving parameters of the manufacturing machines associated with the operation commands.

5. The machine control device according to claim 1, further comprising a peak power estimation unit that estimates the total power consumption and the maximum peak power based on values of the operation commands from the command unit or information about the operating conditions or the power consumption in the storage unit.

6. The machine control device according to claim 1, wherein the operating conditions include a manipulated variable preset for the manufacturing machines.

7. The machine control device according to claim 1, further comprising a power facility planning unit that produces a plan to increase or reduce the power supply capacity of the power facility based on a decision result of the power excess/shortage decision unit and outputs contents of the plan.

8. The machine control device according to claim 1, wherein the command unit outputs, as the operation command, at least one of a command about at least a speed, current, or torque of the manufacturing machine and an offset command about operation start timing of the manufacturing machine.

9. A production system comprising:
the machine control device according to claim 1; and
a host computer that is connected so as to communicate with the machine control device and indicates a production plan to the machine control device,
the host computer including a database unit that receives and stores the information from the storage unit.
